(19) United States
(12) Patent Application Publication
(10) Pub. No.: US 2023/0385079 A1
(43) Pub. Date: Nov. 30, 2023

(54) RENDERING GRAPHICAL ELEMENTS ON AN INTERFACE

(71) Applicant: Microsoft Technology Licensing, LLC, Redmond, WA (US)

(72) Inventors: Iris Mano OLIVER, Seattle, WA (US); Vu N. LE, Redmond, WA (US); Aniket Ashok PATANKAR, Redmond, WA (US); Jeffrey Matthew SMITH, Monroe, WA (US); Sandra JELACIC, Seattle, WA (US); Christoffer Peter Hart HANSEN, Seattle, WA (US); Nicholas SEHY, Seattle, WA (US); Hanna MCLAUGHLIN, Redmond, WA (US); Takanobu MURAYAMA, Tokyo (JP); Byoung Hoon SHIN, Kawasaki (JP); Yusuke BOU, Tokyo (JP); Brian David CROSS, Seattle, WA (US); Andrew ZHYGMANOVSKY, Tokyo (JP); Kirsten RUE, Seattle, WA (US); Pawel RUSIN, Toyko (JP); Abigail STEINEM, Seattle, WA (US)

(21) Appl. No.: 17/829,151

(22) Filed: May 31, 2022

(51) Int. Cl. G06F 9/451; G06F 3/04845; G06F 3/0482; G06F 3/04817; G06T 11/00

(52) U.S. Cl. CPC G06F 9/451; G06F 3/04845; G06F 3/0482; G06F 3/04817; G06T 11/00

(57) ABSTRACT

Graphic elements may be rendered on an interface. An original view of a user interface is presented on at least one display. The user interface initially includes content presented on one or more of a first layer, a second layer, and a third layer. In response to receiving a first input, the user interface in presented in an edit view that includes presenting a menu that includes a plurality of selectable graphic elements. A second input is received that selects a graphic element of the plurality of selectable graphic elements, and third input is received to exit the edit view and present an updated version of the original view. The updated view includes the content presented on the one or more of the first layer, the second layer, and the third layer and the selected graphic element presented on the second layer.

### BACKGROUND

Electronic devices, including mobile electronic devices, tablets, laptop computers, and so forth, are increasingly utilized in the workplace and in educational environments. In particular, these electronic devices are becoming increasingly prevalent in educational environments for children. In both educational and professional settings, electronic devices may be issued to a user for use in limited purposes and/or environments and include restrictions on modifications to the electronic device. For example, semi-permanent markings on the electronic device, such as stickers, may be prohibited by the organization issuing the device. These restrictions present a challenge to the user, who may want to personalize or otherwise modify the electronic device to make the device more personal, relatable, and effective for the user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples and implementations disclosed herein are directed to systems and methods that render one or more graphic elements on an interface. The method includes presenting an original view of a user interface on at least one display, the user interface comprising content presented on one or more of a first layer, a second layer, and a third layer; in response to receiving a first input, presenting the user interface in an edit view, wherein the edit view includes presenting a menu on the user interface, the menu including a plurality of selectable graphic elements; receiving a second input selecting a graphic element of the plurality of selectable graphic elements; and receiving a third input to exit to edit view and presenting an updated view, wherein the updated view includes the content presented on the one or more of the first layer, the second layer, and the third layer and the selected graphic element presented on the second layer.

### BRIEF DESCRIPTION OF THE DRAWINGS

The present description will be better understood from the following detailed description read in light of the accompanying drawings, wherein:

FIG. 1 is a block diagram illustrating an example computing device for implementing various examples of the present disclosure;

FIG. 2 is a block diagram illustrating an example system for rendering graphical elements on an interface according to various examples of the present disclosure;

FIGS. 3A-3C illustrate exploded views of various examples of an interface according to various examples of the present disclosure;

FIGS. 4A-4G illustrate examples of an interface according to various examples of the present disclosure; and

FIG. 5 is a flow chart illustrating a computer-implemented method for rendering graphical elements on an interface according to various examples of the present disclosure.

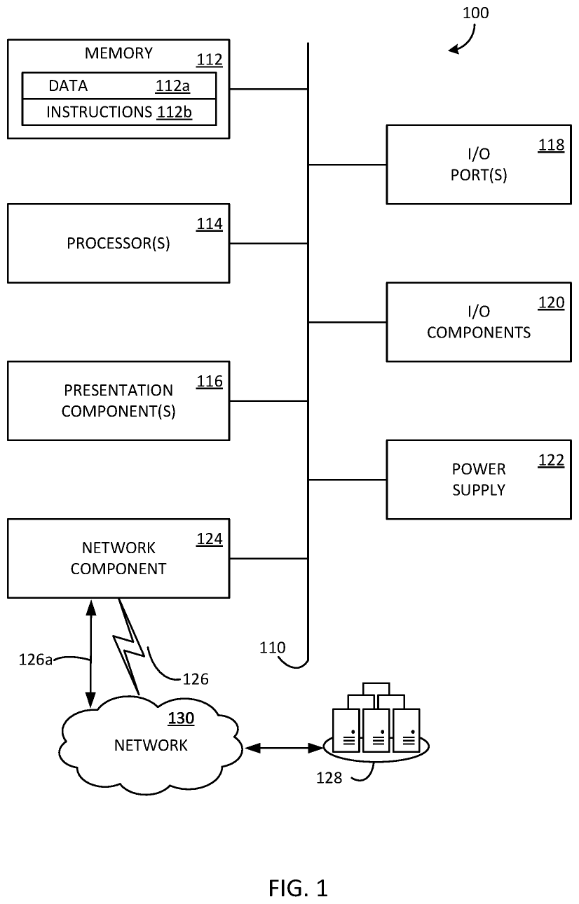

Corresponding reference characters indicate corresponding parts throughout the drawings. In FIGS. 1 to 5, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, due to restrictions in a workplace and/or professional settings, a user may have limited options to personalize an electronic device. For example, applying physical markings on the electronic device, such as applying stickers, writing on the electronic device, and so forth, may be prohibited, unlike when a customer purchases a device on their own for personal use. These restrictions may be in place because, throughout the life of an electronic device, the electronic device may be issued to multiple users. For example, in an educational environment, an electronic device may be issued to a student for the duration of a semester, term, school year, and so forth, and upon the beginning of a new semester, term, or school year be issued to a different student. However, the user may still wish to personalize the electronic device to express themselves and make the electronic device feel more comfortable.

The present disclosure addresses these and other deficiencies by disclosing systems and methods for rendering one or more graphic elements on the user interface of a display. A graphic element may be presented on a middle layer of the user interface, between a front layer that presents application interfaces and shortcut icons and a rear layer that presents a background for the user interface. Accordingly, the graphic element functions as a virtual sticker that may be placed on the background of the user interface to personalize the electronic device without applying a permanent or semi-permanent physical marking on the electronic device, but does not affect the functionality of the application interface(s), shortcut icon(s), and/or task bar.

Although described herein as rendering one or more graphic elements on the user interface of the display, it should be understood these examples are presented for illustration only and should not be construed as limiting. Various implementations are considered. Graphic elements may be rendered on a lock screen, a widget dashboard, and so forth without departing from the scope of the present disclosure.

FIG. 1 is a block diagram illustrating an example computing device 100 for implementing aspects disclosed herein and is designated generally as computing device 100. Computing device 100 is but one example of a suitable computing environment and is not intended to suggest any limitation as to the scope of use or functionality of the examples disclosed herein. Neither should the computing device 100 be interpreted as having any dependency or requirement relating to any one or combination of components/modules illustrated.

The examples disclosed herein may be described in the general context of computer code or machine- or computer-executable instructions, such as program components, being executed by a computer or other machine. Program components include routines, programs, objects, components, data structures, and the like that refer to code, performs particular tasks, or implement particular abstract data types. The disclosed examples may be practiced in a variety of system configurations, including servers, personal computers, laptops, smart phones, servers, virtual machines (VMs), mobile tablets, hand-held devices, consumer electronics, specialty computing devices, etc. The disclosed examples may also be practiced in distributed computing environments when tasks are performed by remote-processing devices that are linked through a communications network.

The computing device 100 includes a bus 110 that directly or indirectly couples the following devices: computer-storage memory 112, one or more processors 114, one or more presentation components 116, I/O ports 118, I/O components 120, a power supply 122, and a network component 124. While the computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 1 and the references herein to a “computing device.”

Memory 112 may take the form of the computer-storage memory device referenced below and operatively provide storage of computer-readable instructions, data structures, program modules and other data for the computing device 100. In some examples, memory 112 stores one or more of an operating system (OS), a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100, including, for example but without limitation: WINDOWS® developed by the MICROSOFT CORPORATION®, MAC OS® developed by APPLE, INC.® of Cupertino, Calif, ANDROID™ developed by GOOGLE, INC.® of Mountain View, California, open-source LINUX®, and the like.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, CPU, GPU, ASIC, system on chip (SoC), or the like for provisioning new VMs when configured to execute the instructions described herein.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor 114, by multiple processors 114 within the computing device 100, or by a processor external to the client computing device 100. In some examples, the processor(s) 114 are programmed to execute instructions such as those illustrated in the flow charts discussed below and depicted in the accompanying figures. Moreover, in some examples, the processor(s) 114 represent an implementation of analog techniques to perform the operations described herein. For example, the operations are performed by an analog client computing device 100 and/or a digital client computing device 100.

Presentation component(s) 116 present data indications to a user or other device. Example presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

The computing device 100 may communicate over a network 130 via network component 124 using logical connections to one or more remote computers. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN); metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

As described herein, the computing device 100 may be implemented as one or more electronic devices such as servers, laptop computers, desktop computers, mobile electronic devices, wearable devices, tablets, and so forth. The computing device 100 may be implemented as a system 200 as described in greater detail below.

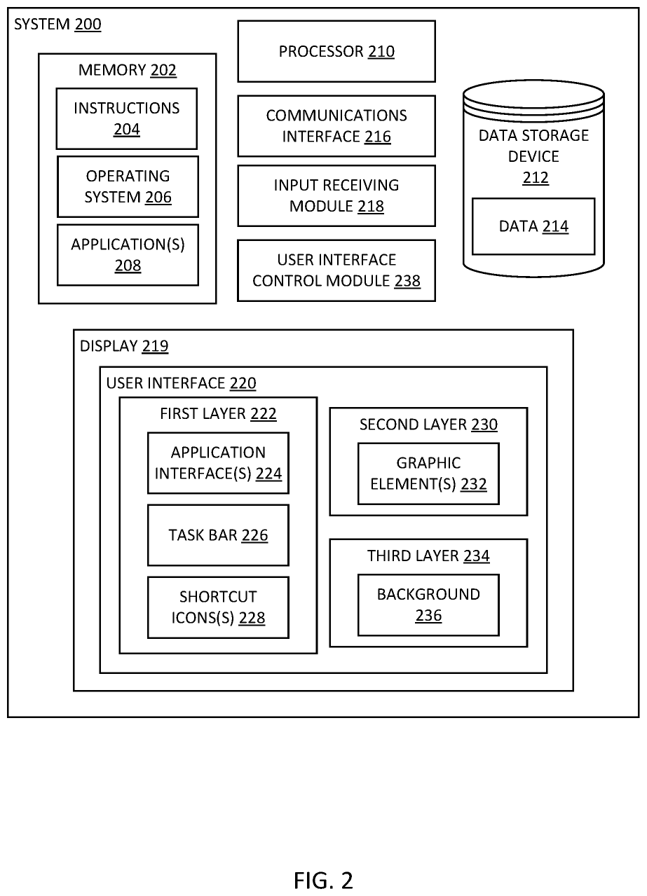

FIG. 2 is a block diagram illustrating an example system for rendering graphical elements on an interface according to various examples of the present disclosure. The system 200 may include the computing device 100. In some implementations, the system 200 is presented as a single computing device that contains each of the components of the system 200. In some implementations, the system 200 includes a cloud-implemented server that includes each of the components of the system 200 described herein.

The system 200 includes a memory 202, a processor 210, a data storage device 212, a communications interface 216, an input receiving module 218, a user interface 220, and a user interface control module 238. The memory 202 stores instructions 204 executed by the processor 210 to control the communications interface 216, the input receiving module 218, the user interface 220, and the user interface control module 238. The memory further stores an operating system (OS) 206. The OS 206 may be executed by the processor 210 and/or one or more elements implemented on the processor 210 to control one or more functions of the system 200. In one example, the user interface control module 238 may execute an element of the OS 206 to render one or more of the first layer 222, the second layer 230, and the third layer 234 of the user interface 220, including various elements presented on the respective layers of the user interface 220.

The memory 202 further stores data, such as instructions for one or more applications 208. An application 208 is a program designed to carry out a specific task on the system 200. For example, the applications 208 may include, but are not limited to, drawing applications, paint applications, web browser applications, messaging applications, navigation/mapping applications, word processing applications, game applications, an application store, applications included in a suite of productivity applications such as calendar applications, instant messaging applications, document storage applications, video and/or audio call applications, and so forth, and specialized applications for a particular system 200. The applications 208 may communicate with counterpart applications or services, such as web services. In some implementations, the applications 208 include an application that enables a user to select one or more graphic elements 232 to be rendered on the user interface 220. For example, the user interface control module 238, described in greater detail herein, may execute the application 208 and render one or more graphic elements 232 on the second layer 230 of the user interface 220. In some implementations, one or more of the applications 208 include a client-facing application interface 224 that is presented on the first layer 222 of the user interface 220, as described in greater detail below.

The processor 210 executes the instructions 204 stored on the memory 202 to perform various functions of the system 200. For example, the processor 210 controls the communications interface 216 to transmit and receive various signals and data, and controls the data storage device 212 to store particular data 214. In some implementations, other elements of the system 200, such as the user interface control module 238, are implemented on the processor 210 to perform specialized functions. For example, the user interface control module 238 controls the user interface 220 to display various graphics and content, including but not limited to application interfaces 224, a task bar 226, one or more shortcut icons 228, one or more graphic elements 232, and one or more backgrounds 236.

The data storage device 212 stores data 214. The data 214 may include any data, including data related to one or more of the applications 208, the task bar 226, the one or more shortcut icons 228, the one or more graphic elements 232, and the one or more backgrounds 236. In some examples, the data 214 may include a graphic elements menu 406, described in greater detail below, from which one or more graphic elements 232 may be selected for rendering on the user interface 220.

The input receiving module 218 is implemented by the processor 210 and receives one or more inputs provided to the system 200. For example, the input receiving module 218 may receive inputs from elements including, but not limited to, a touchpad, a touch display, a keyboard, and so forth. In some implementations, the input receiving module 218 receives inputs provided externally by a computing device included in the system 200, such as a mouse, a joystick, or an external keyboard. In some implementations, the input receiving module 218 receives one or more inputs selecting content presented on the user interface 220.

In some implementations, the system 200 further includes a display 219. The display 219 may be an in plane switching (IPS) liquid-crystal display (LCD), an LCD without IPS, an organic light-emitting diode (OLED) screen, or any other suitable type of display. In some implementations, the display 219 is integrated into a device comprising the system 200, such as a display 219 of a laptop computer. In some implementations, the display 219 is presented external to one or more components included in the system 200, such as an external monitor or monitors.

The user interface 220 presents content on the display 219. For example, the user interface 220 may present one or more of the one or more application interfaces 224, the task bar 226, the one or more shortcut icons 228, the one or more graphic elements 232, and the one or more backgrounds 236. In some implementations, the user interface 220 includes a virtual architecture that presents the content on the display 219 as a plurality of layers. For example, as illustrated in FIG. 2, the user interface 220 may include a first layer 222, a second layer 230, and a third layer 234. Although illustrated and described herein as including three layers, various examples are possible. The user interface 220 may include more or fewer than three layers without departing from the scope of the present disclosure.

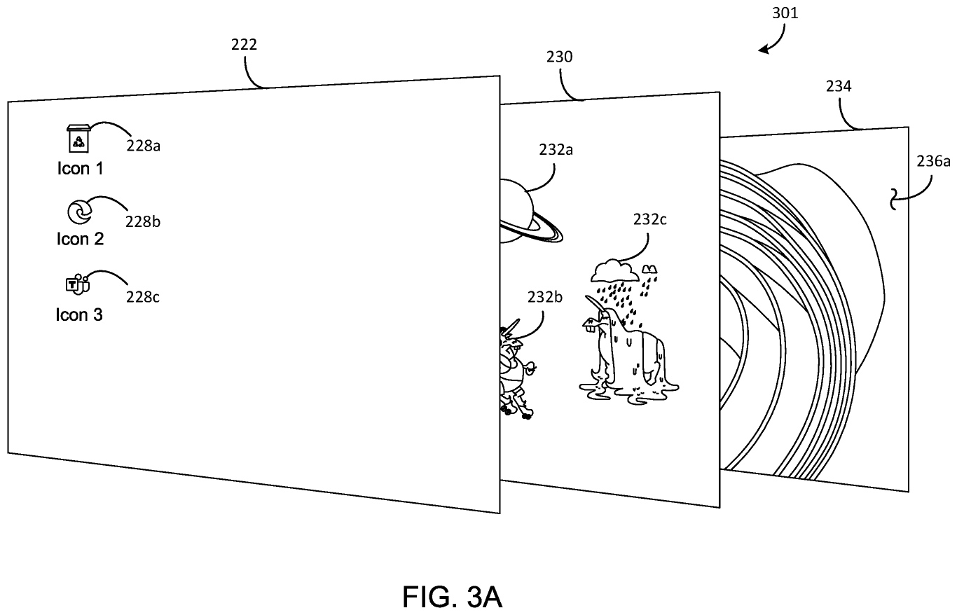

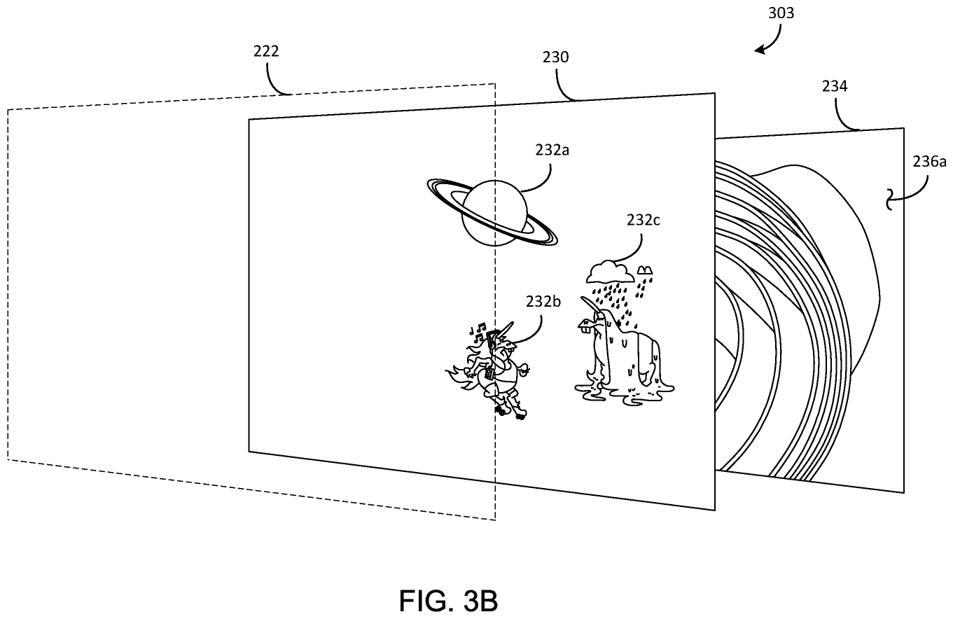

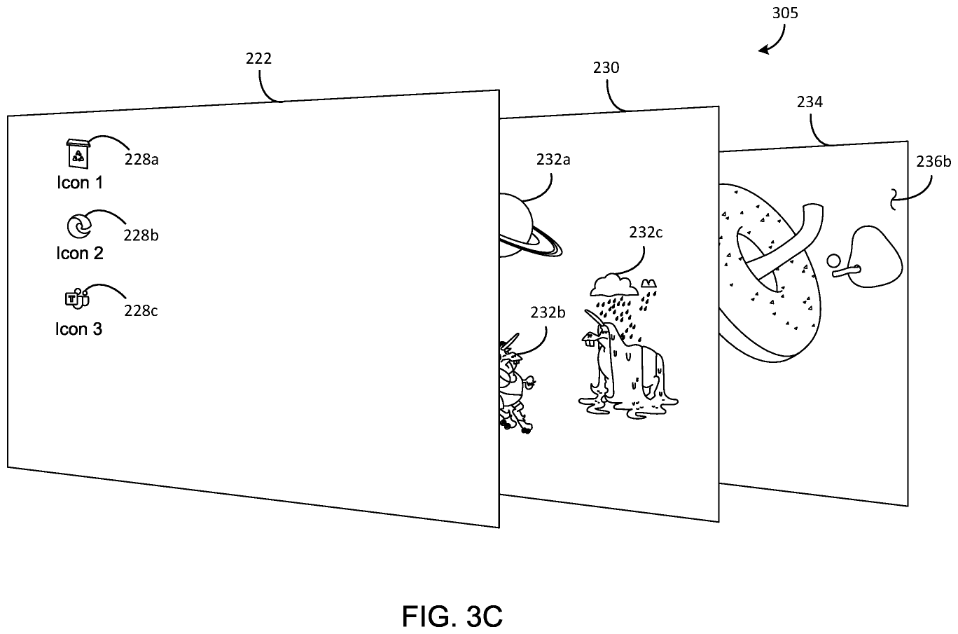

The first layer 222 may be a layer presented in the forefront of the user interface 220. The first layer 222 may include an application interface 224 of the application or applications 208 presently being presented on the user interface 220, a task bar 226, and shortcut icons 228. A shortcut icon 228 is a selectable icon that is a shortcut for a user to select a particular application 208 to launch. A task bar 226 may include one or more shortcut icons 228. The third layer 234 may be a layer that presents a background 236 for the user interface 220. For example, the background 236 may be a desktop background that is presented on the display 219. The background 236 may be an image. The second layer 230 may be a layer presented between the first layer 222 and the third layer 234. The second layer 230 may present one or more graphic elements 232. The first layer 222, the second layer 230, and the third layer 234 are described in greater detail below in the description of FIGS. 3A-3C.

The user interface control module 238 may be implemented on the processor 210 to control one or more features or functions of the user interface 220. For example, the user interface control module 238 may control the user interface 220 to perform various functions including, but not limited to, updating the background 236, presenting an updated application interface 224, rendering one or more graphic elements 232, moving one or more graphic elements 232, rotating one or more graphic elements 232, resizing one or more graphic elements 232, and so forth.

A graphic element 232 may be presented on the second layer 230 of the user interface 220. A graphic element 232 is a virtual sticker that may be presented on the user interface 220 between the content presented on the first layer 222 and the third layer 234. When presented on the user interface 220 in an original view, where the graphic element 232 is not actively being edited as in an edit mode, the graphic element 232 may not be selectable by an input received by the input receiving module 218. In some implementations, the graphic element 232 is static. In other words, the graphic element 232 is presented as an image that does not include animation. In other implementations, the graphic element 232 is dynamic. In other words, at least a part of the graphic element 232 may be animated be presented as a .GIF, a video, and so forth.

In some examples, the graphic element 232 may be selected for presentation from a menu, such as the graphic elements menu 406 described in greater detail below, that presents a selection of graphic elements 232. In other examples, the graphic element 232 may be manually generated. For example, the graphic element 232 may be generated by saving an image and transferring the image to the graphic elements menu 406. In another example, the graphic element 232 may be generated through an inking application, enabling a user to manually create an image and transferring the image to the graphic elements menu 406. In another example, a particular educational environment, such as a school or school district, may generate or aggregate approved, e.g., educationally and/or grade level appropriate, graphic elements that may be made available on devices used within the educational environment. Upon generation, a manually generated graphic element 232 may be automatically added to the user interface 220 or may be automatically added the graphic elements menu 406 for selection. In yet another example, the graphic element 232 may be received from an external device. For example, in an educational environment, an electronic device used by one student may receive a graphic element from a device associated with another student, a teacher, or an administrator via the communications interface 216 that may be automatically added to the user interface 220 or may be automatically added the graphic elements menu 406 for selection. In yet another example, graphic elements may be generated by including images, such as those captured by a camera, within the graphic elements menu 406.

In some implementations, the graphic element 232 persists until manually removed. For example, following selection of the graphic element 232, the graphic element 232 may persist, i.e., continue to be displayed, on the user interface 220 in the same location, size, orientation, and so forth until the graphic element is explicitly removed, or unselected. For example, the graphic element 232 may persist through changes, or updates, to the background 236, through changes to the content presented on the first layer 222, through shutting down and restarting the system 200, and so forth. In other implementations, the graphic element 232 may persist for a predetermined amount of time. The predetermined amount of time may be a specific time period, such as one hour, two hours, twelve hours, twenty-four hours, and so forth, or may be correlated to another aspect of the system 200. For example, the graphic element 232 may be automatically removed from the user interface 220 upon the system 200 shutting down and restarting.

FIGS. 3A-3C illustrate exploded views of various examples of an interface according to various examples of the present disclosure. In particular, FIG. 3A illustrates an interface including a plurality of layers, FIG. 3B illustrates updating a second layer of the interface, and FIG. 3C illustrates updating a third layer of the interface. The examples of the interface illustrated in FIGS. 3A-3C are for illustration only and should not be construed as limiting. Various examples of interface may be used without departing from the scope of the present disclosure.

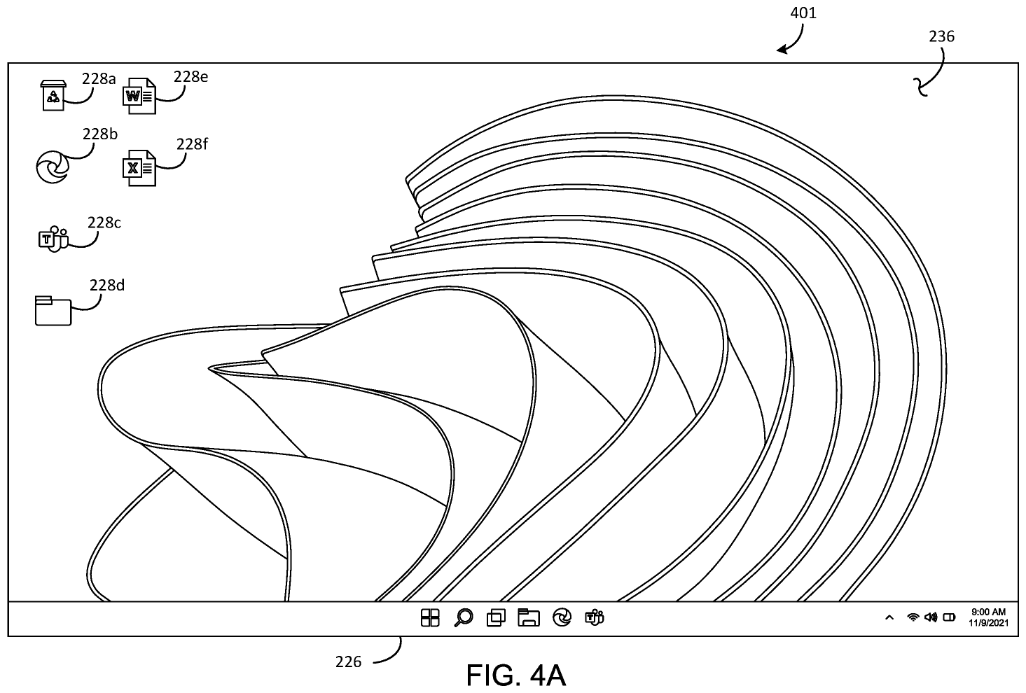

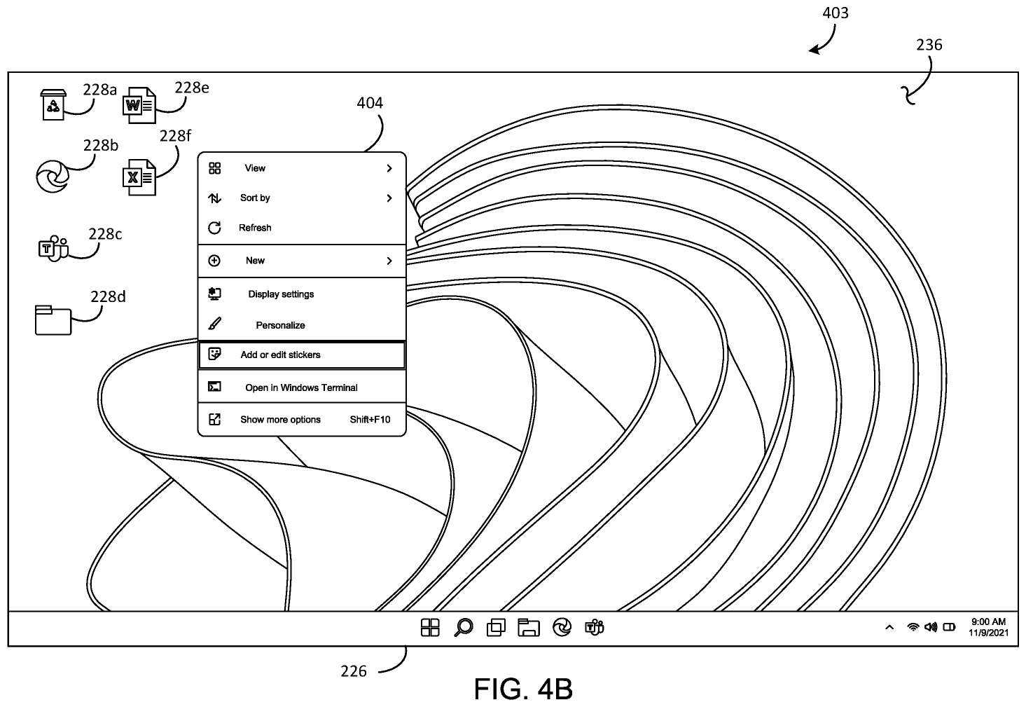

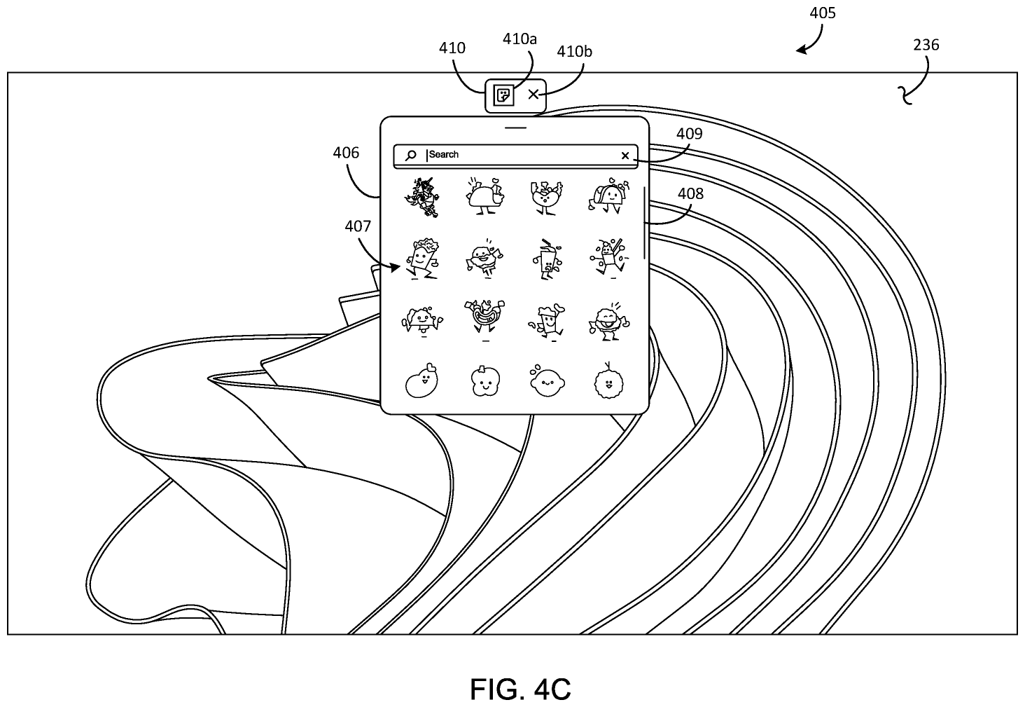

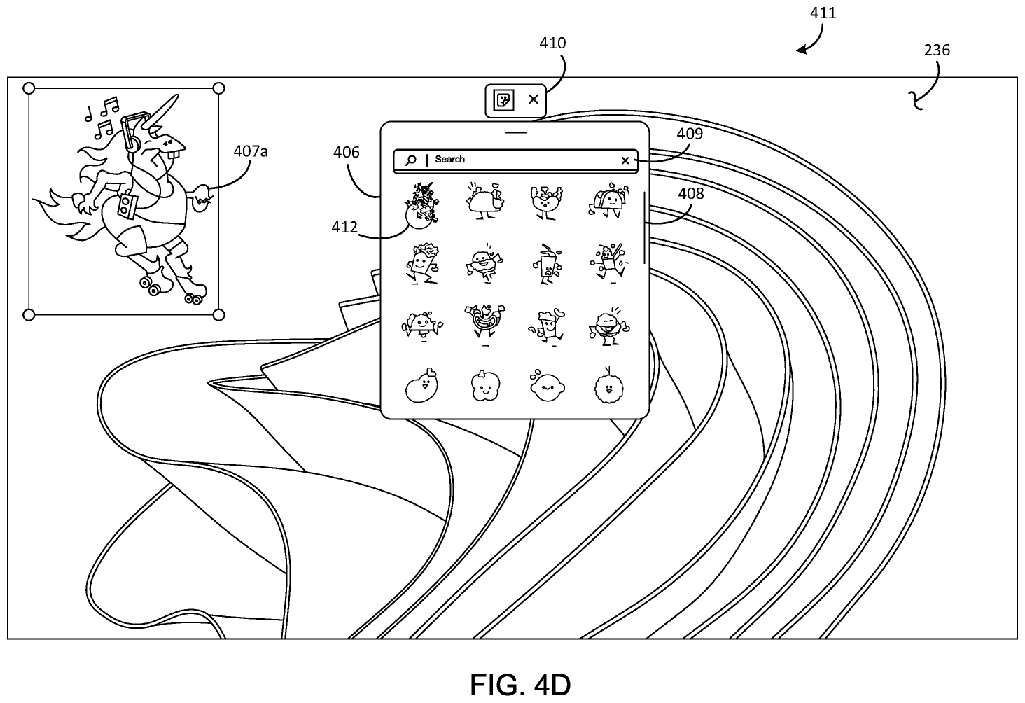

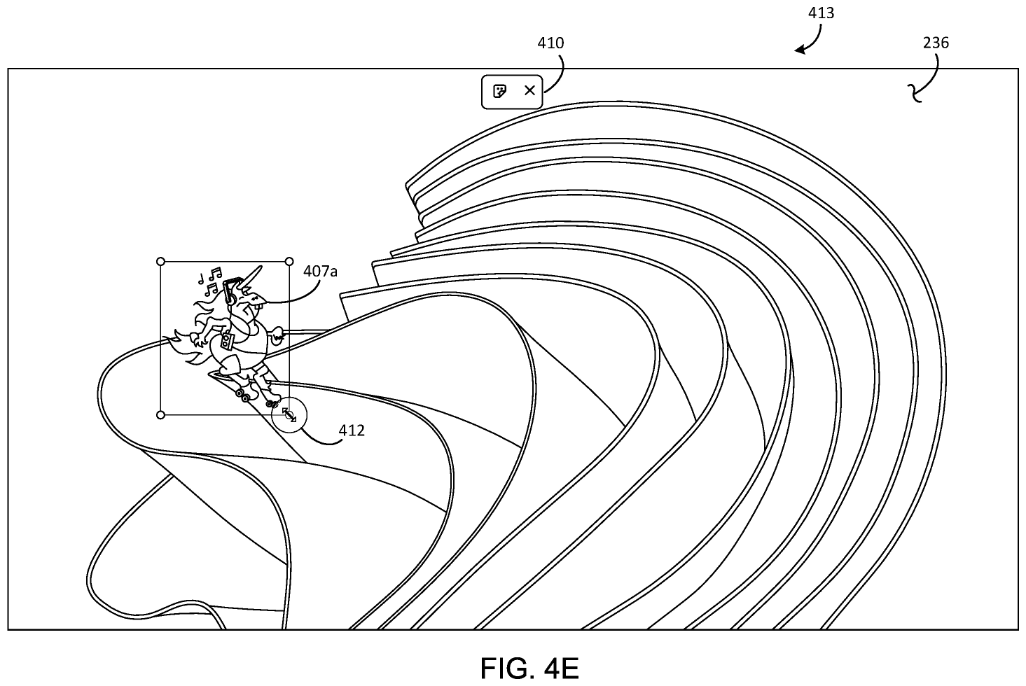

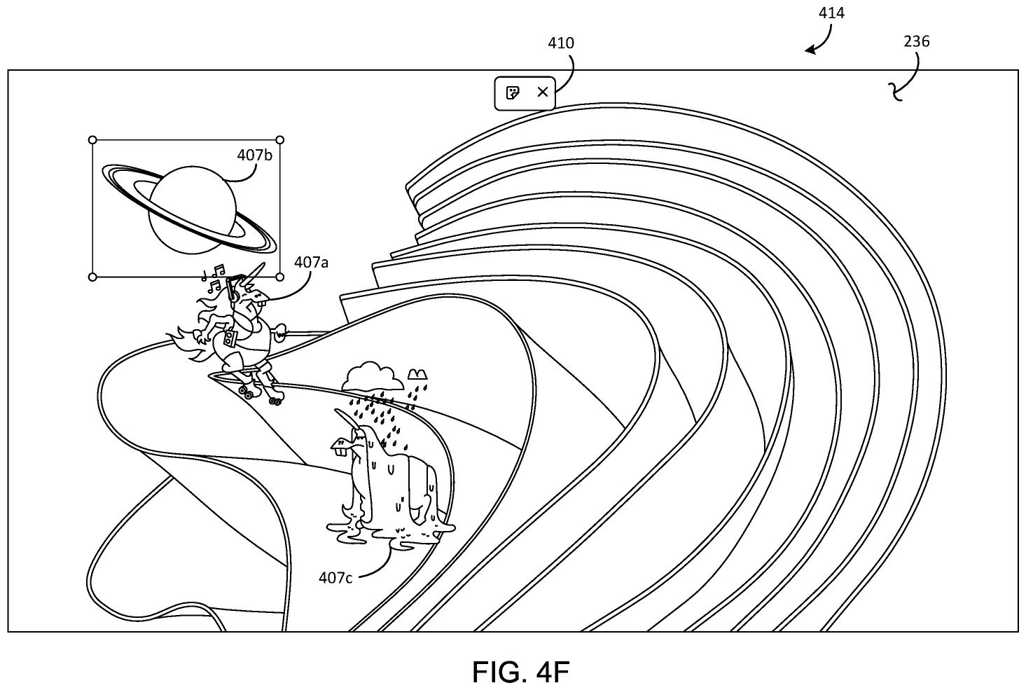

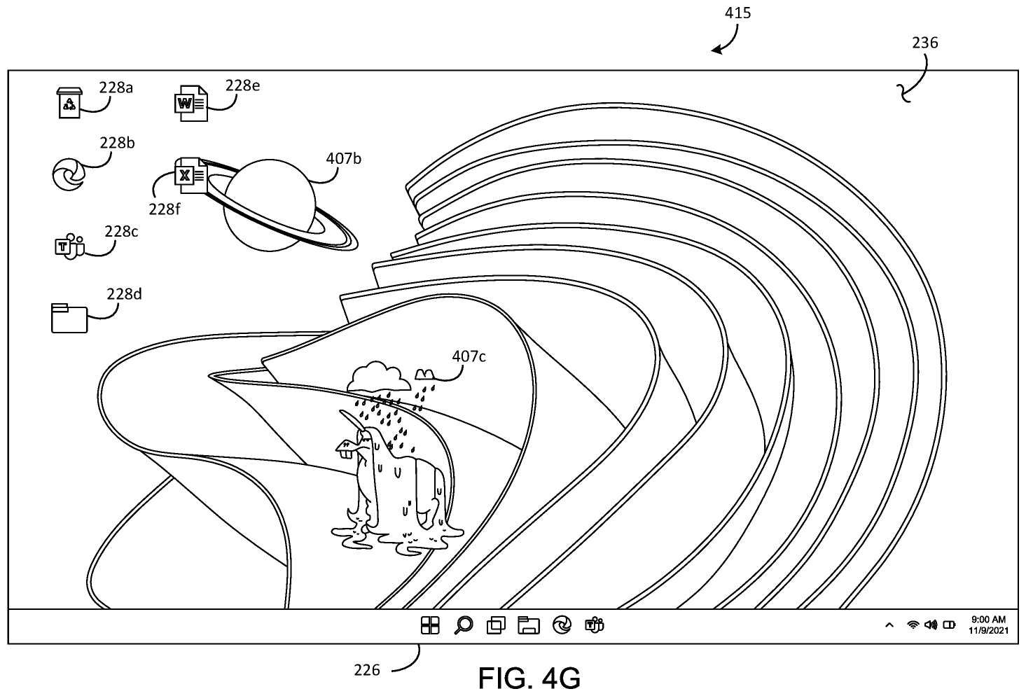

FIG. 3A illustrates a first exploded view 301 of an example user interface 220 presented in a default view according to various implementations of the present disclosure. The user interface 220 includes the first layer 222, the second layer 230, and the third layer 234. It should be understood that although described herein as the first layer 222, the second layer 230, and the third layer 234, when presented on the display 219, the user interface 220 may present a single, unified view that includes aspects from one or more of each of the first layer 222, the second layer 230, and the third layer 234, for example as illustrated in FIGS. 4A-4G.

A plurality of shortcut icons 228 are presented on the first layer 222. The plurality of shortcut icons 228 may include a first icon 228a, a second icon 228b, and a third icon 228c, but other examples are contemplated. For example, the first layer 222 may include more or fewer than three icons 228, the task bar 226, and/or one or more application interfaces 224. The first layer 222 is presented on top of, or in front of, the second layer 230 and the third layer 234. In other words, the content presented on the first layer 222 is overlaid on the content presented on the second layer 230 and the third layer 234. For example, as shown in greater detail below with regards to FIGS. 4A through 4G, the content presented on the first layer 222, i.e., the plurality of shortcut icons 228, is presented on the user interface 220 on top of, or in front of, the content presented on the second layer 230 and the third layer 234.

A plurality of graphic elements 232 are presented on the second layer 230. The plurality of graphic elements may include a first graphic element 232a, a second graphic element 232b, and a third graphic element 232c, but other examples are contemplated. For example, the second layer 230 may include more or fewer than three graphic elements. The second layer 230 is presented behind, or below, the first layer 222 and on top of, or in front of, the third layer 234. In other words, the second layer 230 is presented between the first layer 222 and the third layer 234. Content presented on the second layer 230, such as the plurality of graphic elements 232, is overlaid on the content presented on the third layer 234. For example, as shown in greater detail below with regards to FIGS. 4A through 4G, the content presented on the second layer 230, i.e., the plurality of graphic elements 232, is presented on the user interface 220 on top of, or in front of, the content presented on the third layer 234.

A background 236 is presented on the third layer 234. The background 236 may be an image, a logo, a design, or any other type of background presented on a wallpaper that is presented on the user interface 220. The background 236 may be a constant background or a background that may be changed or updated. For example, the first exploded view 301 illustrates a first background 236a, while the third exploded view 305 of FIG. 3C illustrates a second background 236b. The background 236 may be updated manually or may be automatically updated periodically, such as at a predetermined interval. The third layer 234 is presented behind, or below, each of the first layer 222 and the second layer 230. As shown in greater detail below with regards to FIGS. 4A through 4G, the content presented on the first layer 222 is overlaid on the content presented on the second layer 230, and the content presented on the second layer 230 is overlaid on the content presented on the third layer 234.

In some implementations, a default view, for example the first view 401 illustrated in FIG. 4A and described in greater detail below, for the user interface 220 includes content presented on the first layer 222 overlaying content presented on the second layer 230 overlaid with content presented on the third layer 234. For example, the user interface 220 is presented on a display or displays 219 and the user interface control module 238 controls the one or more shortcut icons 228 to be overlaid on a graphic element or elements 232, which are each overlaid on the background 236.

FIG. 3B illustrates a second exploded view 303 of an example user interface 220 presented in an edit view according to various implementations of the present disclosure. The edit view is illustrated in FIGS. 4C-4F and described in greater detail below. In some implementations, the user interface control module 238 controls the user interface 220 to present the edit view. The user interface control module 238 may control the user interface 220 to present the edit view based on the input receiving module 218 receiving an input to enter the edit view. For example, the input receiving module 218 may detect an input, i.e., a first input. In some examples, the first input is received in the form of a right-click on a mouse or an input on a touchpad on an area of the user interface 220 that otherwise does not present selectable content such as an icon 228. In another example, the first input is received in the form of a voice input from a microphone included in the communications interface 216. Based on the received input, the user interface control module 238 controls the user interface 220 to present a settings menu. The input receiving module 218 may receive an additional input, i.e., a second input, selecting to enter the edit view.

Although the process of entering the edit view is described herein as a two-stage process that includes receiving a first input and a second input, it should be understood these examples are presented for illustration only and should not be construed as limiting. Various implementations are considered. For example, the edit view may be entered automatically as a step during the setup process of a device implemented within the system 200. Automatically entering the edit view during setup of the device introduces a user of the device to the graphic element features, particularly when the user may have little to no prior experience with the graphic element features and/or the electronic device more generally.

As illustrated in FIG. 3B, when the user interface 220 is presented in edit view, the user interface control module 238 controls the first layer 222 to not present content and instead presents the second layer 230 as the first layer of content. In other words, FIG. 3B illustrates that the plurality of shortcut icons 228 are not presented on the user interface 220, but the plurality of graphic elements 232 are presented overlaid the background 236. By not presenting content associated with the first layer 222 while in the edit view, the user interface 220 may presented a more simplified view that does not include the plurality of shortcut icons 228, the taskbar 226, and other application content in order to draw the user's attention to the plurality of graphic elements 232 presented on the background 236. As described in greater detail below, the edit view enables graphic elements 232 to be selected, removed, moved, rotated, resized, and/or otherwise modified. While in the edit view, the input receiving module 218 may receive a third input indicating to exit the edit view. Upon exiting the edit view, the user interface control module 238 controls the user interface 220 to return to the default view as illustrated in FIG. 3A.

FIG. 3C illustrates a third exploded view 305 of an example user interface 220 presented in the default view according to various implementations of the present disclosure. The third exploded view 305 illustrates a view similar to the first exploded view 301, but with an updated background 236. For example, as shown in FIG. 3C, a second background 236b is presented on the third layer 234. In some implementations, the background 236 is updated automatically, such as at a regular interval. In other implementations, the background 236 is updated manually by a user. For example, the user may manually select a specific image or design to be used as the second background 236b through an operating system settings menu or by selecting a particular image and providing a series of inputs. It should be understood that the plurality of shortcut icons 228 and the plurality of graphic elements 232 are presented in FIG. 3C in the same manner as presented in FIG. 3A. In other words, the user interface control module 238 controls the one or more shortcut icons 228 to be overlaid on a graphic element or elements 232, which are each overlaid on the second background 236b. Accordingly, the update of the background 236 from the first background 236a illustrated in the first exploded view 301 to the second background 236b illustrated in the third exploded view 303 has no effect on the first layer 222 or the second layer 230.

FIGS. 4A-4G illustrate examples of an interface according to various examples of the present disclosure. The examples of the interface illustrated in FIGS. 4A-4G are for illustration only and should not be construed as limiting. Various examples of interface may be used without departing from the scope of the present disclosure. FIGS. 4A-4G illustrate a process of adding one or more graphic elements 232 to the second layer 230.

FIG. 4A illustrates a first view 401 of the user interface 220 presented in the default view, such as illustrated in FIGS. 3A and 3C. In some examples, the first view 401 is referred to as an original view. For example, the first view 401 illustrates a task bar 226 and a plurality of shortcut icons 228, including the first icon 228a, the second icon 228b, the third icon 228c, a fourth icon 228d, a fifth icon 228e, and a sixth icon 228f. The first view 401 additionally illustrates a background 236. The first view 401 does not illustrate any graphic elements 232 presented on the user interface 220.

FIG. 4B illustrates a second view 403 of the user interface 220. The second view 403 retains the features presented in the first view 401, such as the task bar 226, plurality of shortcut icons 228, and the background 236. The second view 403 further illustrates a settings menu 404. The settings menu 404 is selectable by an additional input and may be presented on the first layer 222 as an example of an application interface 224. For example, the settings menu 404 is shown overlaid on the background 236, so that the portion of the background 236 upon which the settings menu 404 is presented is not visible in the second view 403. The user interface control module 238 may control the user interface 220 to present the settings menu 404 in response to the input receiving module 218 receiving a first input, such as a right-click on a mouse or an input on a touchpad on an area of the user interface 220 that otherwise does not present selectable content such as an icon 228 or through a voice input.

As shown in the second view 403, the settings menu 404 includes a menu of one or more settings that may be selected. The settings menu 404 includes a setting to add or edit graphic elements, or stickers. Upon the input receiving module 218 receiving a second input selecting the setting to add or edit graphic elements, the user interface control module 238 controls the user interface 220 to enter the edit view.

FIG. 4C illustrates a third view 405 of the user interface 220. The third view 405 illustrates the user interface 220 presented in the edit view. As also shown in FIG. 3B described above, in implementations where the user interface 220 is presented in the edit view, content presented on the first layer 222 is not displayed. For example, the task bar 226 and the plurality of shortcut icons 228 are not presented on the user interface 220 in the third view 405. In implementations where the user interface 220 is presented in the edit view, the user interface control module 238 controls the user interface 220 presents a graphic elements menu 406 and a status menu 410 on the second layer 230. The status menu 410 includes a first button 410a to expand or collapse the graphic elements menu 406 and a second button 410b to close the third view 405, which saves the selected graphic element or elements 407 and returns to an updated original view, i.e., an updated view, as illustrated in FIG. 4G. In other implementations, the status menu 410 includes one or more additional buttons, in addition to or instead of the first button 410a and the second button 410b, to open additional menus, receive a search input for a web image, open a palette for inking to generate a new graphic element 407, and so forth.

The graphic elements menu 406 includes a plurality of searchable graphic elements 407 that may be selected for presentation on the user interface 220. In some examples, the graphic elements 232a, 232b, 232c illustrated in FIGS. 3A-3C are examples of the graphic elements 407 that have been selected for presentation on the user interface 220. The graphic elements menu 406 and the plurality of graphic elements 407 included in the graphic elements menu 406 may be stored in the data storage device 212 as the data 214. The graphic elements menu 406 further includes a scroll bar 408 that may be selected and scrolled up and down in order to view additional graphic elements 407 and a search bar 409. The input receiving module 218 may receive an input selecting the search bar 409 and then receive additional inputs, such as from a keyboard, a mouse, or a voice, to search for a particular graphic element 407. The search may include a name of a graphic element 407 and/or a description of a graphic element 407. The status menu 410 is a selectable menu that includes a button 410b that may be selected in order to return the user interface 220 to the default view, such as the first view 401 illustrated in FIG. 4A.

The graphic elements menu 406 may be presented in various formats. As shown in FIG. 4C, the graphic elements menu 406 may include a list of pre-provided graphic elements 407. In other implementations, the graphic elements menu 406 may include various categories of graphic elements 407 that, when selected, present a subset of graphic elements 407 corresponding to the particular selected category. The categories may include, but are not limited to, types of food, different sports, different school subjects, different musical instruments, different animals, different colors, and so forth. In other implementations, the graphic elements menu 406 may include recently used or selected graphic elements 407, graphic elements 407 that have been shared with the device, newly added graphic elements 407, and so forth.

FIG. 4D illustrates a fourth view 411 of the user interface 220. The fourth view 411 illustrates the user interface 220 presented in the edit view as in FIG. 4C, but additionally illustrates a first graphic element 407a that has been selected from the graphic elements menu 406 including the plurality of searchable graphic elements 407. The first graphic element 407a is identified and selected from within the graphic elements menu 406 by a cursor 412. The cursor 412 may be presented as an arrow, a circle, an arrow within a circle, a circle within an arrow, or any other suitable shape or method of highlighting to indicate a graphic element of the plurality of searchable graphic elements 407 to be selected.

FIG. 4E illustrates a fifth view 413 of the user interface 220. The fifth view 413 illustrates the user interface 220 presented in the edit view following the selection of the first graphic element 407a. In particular, the fifth view 413 illustrates the first graphic element 407a moved and resized from the original location shown in the fourth view 411 upon the button 410a being selected to collapse the graphic elements menu 406, allowing the user to view a larger area of the background 236. In particular, the fifth view 413 illustrates the first graphic element 407a having been moved away from the upper left corner of the user interface 220, as illustrated in FIG. 4D, and moved more toward the middle of the user interface 220. In addition, the fifth view 413 illustrates the first graphic element 407a resized, i.e., presented in a smaller size, relative to the size of the graphic element shown in the fourth view 411. In another example, the first graphic element 407a may be rotated in addition to or instead of moved and/or resized. In some examples, the first graphic element 407a is at least one of moved, resized, and rotated based on receiving a selection of the first graphic element 407a. The first graphic element 407a may be selected via the cursor 412, a touch input, a voice input, a stylus input, and so forth. For example, the input receiving module 218 may receive an input selecting the first graphic element 407a, a movement of the cursor, and another input deselecting the first graphic element 407a and indicating the first graphic element 407a has been moved, resized, and/or rotated to the desired location.

FIG. 4F illustrates a sixth view 414 of the user interface 220. The sixth view 414 illustrates the user interface 220 presented in the edit view following the movement and resizing of the first graphic element 407a. The sixth view 414 further illustrates a second graphic element 407b and a third graphic element 407c in addition to the first graphic element 407a. For example, the sixth view 414 may be presented following the process of selecting a graphic element and moving and/or resizing the selected graphic element resulting in the presentation of the fourth view 411 and the fifth view 413, respectively. For example, each of the second graphic element 407b and the third graphic element 407c may be separately selected, and in some instances at least one of moved, resized, and rotated, resulting in the sixth view 414. In some implementations, the various graphic elements may be presented such that one graphic element is layered at least partially on top of another graphic element.

FIG. 4G illustrates a seventh view 415 of the user interface 220. In some examples, the seventh view 415 is referred to as an updated view. For example, the seventh view 415 is similar to the first view 401, i.e., the original view, but is updated to include the selections of the second graphic element 407b and the third graphic element 407c. In some implementations, the seventh view 415 is entered in response to an input being received on the status menu 410 indicating to exit the edit view. The seventh view 415 illustrates the user interface 220 presented in the default view following the second graphic element 407b and the third graphic element 407c being selected in the edit view. In the seventh view 415, the first graphic element 407a has been removed, i.e., unselected, leaving the second graphic element 407b and the third graphic element 407c pretend on the user interface 220. FIG. 4G further illustrates the relationship between the first layer 222, the second layer 230, and the third layer 234. For example, each of the second graphic element 407b and the third graphic element 407c are presented in front of, or on top of, the background 236, illustrating the second layer 230 overlaid on the third layer 234. In addition, the sixth icon 228f is presented in front of, or on top of, the second graphic element 407b, illustrating the first layer 222 overlaid on the second layer 230.

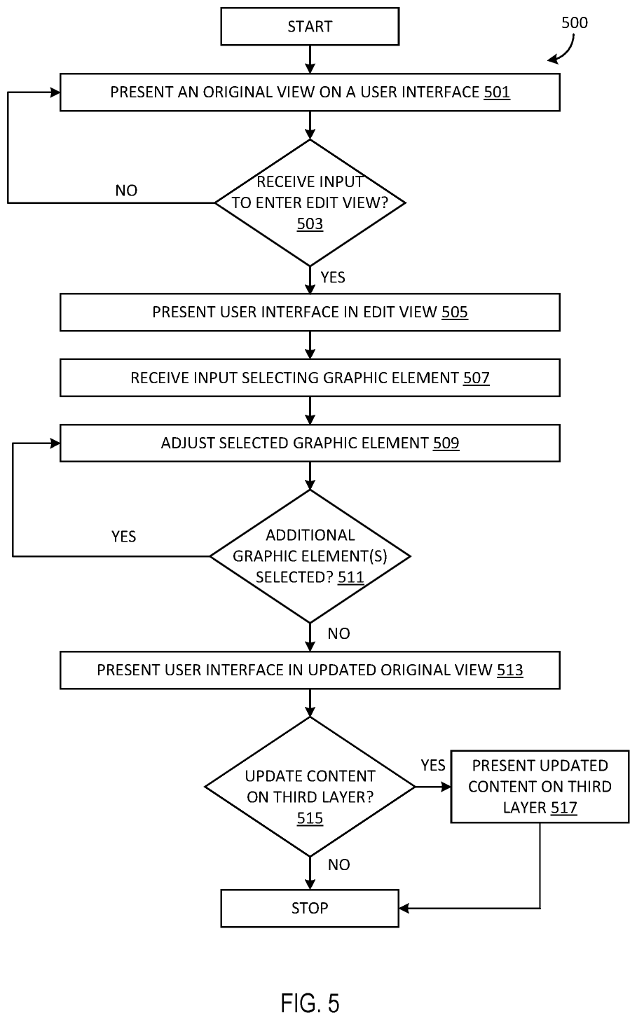

FIG. 5 is a flow chart illustrating a computer-implemented method for rendering graphical elements on an interface according to various examples of the present disclosure. The operations illustrated in FIG. 5 are for illustration and should not be construed as limiting. Various examples of the operations may be used without departing from the scope of the present disclosure. The operations of the flow chart 500 may be executed by one or more components of the system 200, including the processor 210, the input receiving module 218, the display 219, the user interface 220, and the user interface control module 238.

The flow chart 500 begins by presenting an original view of the user interface 220 on at least one display 219 in operation 501. In some examples, the user interface 220 is presented on a single display 219, such as a laptop computer or a computing device connected to a single monitor. In other examples, the user interface 220 is presented on more than one display, such as a laptop computer used in conjunction with a monitor or a computing device connected to more than one monitor. The original view may be the first view 401 illustrated in FIG. 4A. As described herein, the user interface 220 comprises content presented on one or more of the first layer 222, the second layer 230, and the third layer 234. For example, the first layer 222 may present one or more of an application interface 224, a task bar 226, and a shortcut icon 228. The second layer 230 may present one or more graphic elements 232. The third layer 234 may present a background 236.

In operation 503, the user interface control module 238 determines whether the input receiving module 218 receives an input to present the user interface 220 in an edit view. Where no input is received, the user interface control module 238 returns to operation 501 and continues to present the user interface 220 in the original view. Where an input, referred to herein as a first input, is received by the input receiving module 218, the user interface control module proceeds to operation 505 and presents the user interface 220 in an edit view. In some implementations, the first input may include more than one input received by the input receiving module 218. For example, the first input may collectively refer to a plurality of inputs, such as the input received to display the settings menu 404 and the input received to select the setting to add or edit graphic elements from the settings menu 404.

The edit view may be the third view 405 illustrated in FIG. 4C. For example, the edit view may include a graphic elements menu 406 including the plurality of searchable graphic elements 407. As described herein, each of the graphic elements 407 may be an example of a graphic element 232. In some implementations, presenting the user interface 220 in the edit view comprises removing, i.e., not displaying, any content presented on the first layer of the user interface 220 in the original view. For example, the original view may include the presentation of a plurality of shortcut icons 228. In the edit view, the user interface control module 238 does not present the plurality of shortcut icons 228, a task bar 226, or an application interface 224 that may be presented in various examples of the first layer 222.

In operation 507, the input receiving module 218 receives a second input selecting a graphic element 407a from the graphic elements menu 406. The selection may be made by a cursor 412. In some implementations, the flow chart 500 includes the user interface control module 238 adjusting the selected graphic element 407a in operation 509. For example, adjusting the selected graphic element 407a may include one or more moving, resizing, or rotating the selected graphic element 407a on the user interface 220, as illustrated in FIG. 4E.

In operation 511, the user interface control module 238 determines whether additional graphic elements 407 have been selected. The input receiving module 218 may receive one or more additional inputs that select one or more additional graphic elements 407. For example, as shown in FIG. 4F, the input receiving module 218 may receive additional inputs selecting the second graphic element 407b and the third graphic element 407c. However, it should be understood that the example illustrated in FIG. 4F is for illustration only and should not be construed as limiting. More or fewer than two additional graphic elements 407 may be selected without departing from the scope of the present disclosure. Where additional inputs are received, the flow chart 500 returns to operation 509 and optionally adjusts the selected graphic elements 407. Where additional inputs are not received, the flow chart 500 proceeds to operation 513.

In operation 513, the user interface control module 238 presents the user interface 220 in an updated view, for example as illustrated in FIG. 4G. As described herein, the updated view is similar to the original view, such as illustrated in FIG. 4A, with the exception of the inclusion of the selected graphic elements 407. The updated view includes each graphic element 407 selected from the edit view presented on the second layer 230 of the user interface 220. Each graphic element 407 presented on the second layer 230 is presented in front of content presented on the third layer 234 of the user interface 220 and behind content presented on the first layer 222 of the user interface 220.

In operation 515, the user interface control module 238 determines whether content has been updated on the third layer 234. As described herein, the third layer 234 may present a background comprising an image, a logo, a design, or any other type of background presented in the background of the user interface 220. Where content is determined to have been updated, the user interface control module 238 proceeds to operation 517 and presents the updated content on the third layer 234. Where the content on the third layer 234 is updated, the presentation of content on the first layer 222 and the second layer 230 is unaffected and persists. In other words, the selected graphic element or elements 407, plurality of shortcut icons 228, task bar 226, and/or application interfaces 224 presented on the user interface 220 persist as the content presented on the third layer 234 of the user interface 2220 is updated. Where content is not updated, the flow chart 500 terminates.

### ADDITIONAL EXAMPLES

Some examples herein are directed to a computer-implemented method of rendering a graphic element, as illustrated by the flow chart 500. The method (500) includes presenting (501) an original view (401) of a user interface (220) on at least one display (219), the user interface comprising content presented on one or more of a first layer (222), a second layer (230), and a third layer (234); in response to receiving a first input, presenting (505) the user interface in an edit view (405), wherein the edit view includes presenting a menu (406) on the user interface, the menu including a plurality of selectable graphic elements (232, 407); receiving (507) a second input selecting a graphic element (407a) of the plurality of selectable graphic elements; and receiving (513) a third input to exit to edit view and presenting an updated view (415), wherein the updated view includes the content presented on the one or more of the first layer, the second layer, and the third layer and the selected graphic element presented on the second layer.

In some examples, the computer-implemented method further comprises presenting one or more of an application interface (224), a task bar (226), and a shortcut icon (228) on the first layer of the user interface, and presenting a background (236) on the third layer of the user interface.

In some examples, the computer-implemented method further comprises selecting a second graphic element (407b) of the plurality of selectable graphic elements.

In some examples, the updated view further includes the second selected graphic element presented on the second layer.

In some examples, presenting the updated view further includes overlaying the selected graphic element over the second selected graphic element.

In some examples, the computer-implemented method further comprises receiving a fourth input to move, resize, or rotate the selected graphic element on the user interface.

In some examples, presenting the updated view further comprises presenting the selected graphic element on the user interface such that the selected graphic element is presented in front of content presented on the third layer of the user interface.

In some examples, the computer-implemented method further comprises updating (517) the content presented on the third layer of the user interface, wherein the presentation of the selected graphic element on the user interface persists as the content presented on the third layer of the user interface is updated.

In some examples, presenting the user interface in the edit view further comprises removing content that is presented on the first layer in the original view from presentation in the edit view.

In some examples, the menu presented on the user interface in the edit view is a content catalog including the plurality of selectable graphic elements.

Although described in connection with an example computing device 100 and system 200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, servers, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of ” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

1. A computer-implemented method comprising:
presenting an original view of a user interface on at least one a display, the user interface comprising content presented on one or more of a first layer, a second layer, and a third layer, wherein the third layer includes a background of the user interface, wherein the second layer is presented between the first layer and the third layer, and wherein the first layer includes one or more of: an application interface, a task bar, and a selectable shortcut icon;
in response to receiving a first input, presenting the user interface in an edit view, wherein the edit view includes presenting a menu on the user interface, the menu including a selectable graphic element;
receiving a second input selecting the graphic element; and
in response to receiving a third input to exit the edit view, presenting an updated view including the content presented on the one or more of the first layer, the second layer, and the third layer and the selected graphic element presented on the second layer.

2. (canceled)

3. The computer-implemented method of claim 1, further comprising:
selecting a second graphic element, wherein the updated view further includes the second selected graphic element presented on the second layer.

4. The computer-implemented method of claim 3, wherein presenting the updated view further includes overlaying the selected graphic element over the second selected graphic element.

5. The computer-implemented method of claim 1, further comprising:
receiving a fourth input to move, resize, or rotate the selected graphic element on the user interface.

6. The computer-implemented method of claim 1, wherein presenting the updated view further comprises:
presenting the selected graphic element on the user interface such that the selected graphic element is presented in front of content presented on the third layer of the user interface.

7. The computer-implemented method of claim 6, further comprising:
updating the content presented on the third layer of the user interface, wherein the presentation of the selected graphic element on the user interface persists as the content presented on the third layer of the user interface is updated.

8. The computer-implemented method of claim 1, wherein presenting the user interface in the edit view further comprises:
removing content that is presented on the first layer in the original view from presentation in the edit view.

9. The computer-implemented method of claim 1, wherein the menu presented on the user interface in the edit view is a content catalog including the selectable graphic element.

10. A system comprising:
a memory storing instructions that are executable by a processor;
the processor configured to execute the instructions stored on the memory;
a display configured to present a user interface, the user interface comprising content presented on one or more of a first layer, a second layer, and a third layer, wherein the third layer includes a background of the user interface, wherein the second layer is presented between the first layer and the third layer, and wherein the first layer includes one or more of: an application interface, a task bar, and a selectable shortcut icon;
an input receiver implemented on the processor and configured to receive an input; and
a user interface controller, implemented on the processor, configured to:
in response to the input receiver receiving a first input, control the user interface to enter an edit view, wherein the edit view includes presenting a menu on the user interface, the menu including a selectable graphic element,
in response to the input receiver receiving a second input, select the graphic element of the plurality of selectable graphic elements, and
in response to the input receiver receiving a third input, control the user interface to exit the edit view and present an updated view including the content presented on the one or more of the first layer, the second layer, and the third layer and the selected graphic element presented on the second layer.

11. (canceled)

12. The system of claim 10, wherein the user interface controller is further configured to:
in response to the input receiver receiving a fourth input, select a second graphic element, wherein the updated view further includes the second selected graphic element presented on the second layer.

13. The system of claim 12, wherein, to present the updated view, the user interface controller is further configured to:
overlay the selected graphic element over the second selected graphic element.

14. The system of claim 10, wherein the user interface controller is further configured to:
in response to receiving a fourth input, perform at least one of moving, resizing, or rotating the selected graphic element on the user interface.

15. The system of claim 10, wherein, to present the updated view, the user interface controller is further configured to:
present the selected graphic element on the user interface such that the selected graphic element is presented in front of content presented on the third layer of the user interface.

16. The system of claim 15, wherein the user interface controller is further configured to:
update the content presented on the third layer of the user interface,
wherein the presentation of the selected graphic element on the user interface persists as the content presented on the third layer of the user interface is updated.

17. The system of claim 10, wherein, to present the edit view, the user interface controller is further configured to:
remove content that is presented on the first layer in the original view from presentation in the edit view.

18. The system of claim 10, wherein the menu presented on the user interface in the edit view is a content catalog including the selectable graphic element.

19. One or more computer-storage memory devices embodied with executable instructions that, when executed by a processor, cause the processor to:
control a display to present a user interface, the user interface comprising content presented on one or more of a first layer, a second layer, and a third layer, wherein the third layer includes a background of the user interface, wherein the second layer is presented between the first layer and the third layer, and wherein the first layer includes one or more of: an application interface, a task bar, and a selectable shortcut icon; and
control a user interface controller to:
in response to an input receiver receiving a first input, control the user interface to enter an edit view, wherein the edit view includes presenting a menu on the user interface, the menu including a selectable graphic element,
in response to the input receiver receiving a second input, select the graphic element,
in response to the input receiving module receiver receiving a third input, control the user interface to exit the edit view and present an updated view including the content presented on the one or more of the first layer, the second layer, and the third layer and the selected graphic element presented on the second layer, and
update the content presented on the third layer, wherein the presentation of the selected graphic element on the user interface persists as the content presented on the third layer of the user interface is updated.

20. The one or more computer-storage memory devices of claim 19, wherein, to present the edit view, the instructions further cause the processor to:
control the user interface controller to remove content that is presented on the first layer in the original view from presentation in the edit view.

21. The computer-implemented method of claim 1, further comprising:
saving an image and transferring the saved image to the menu as the graphic element.

22. The computer-implemented method of claim 1, wherein presenting the user interface in the edit view further comprises:
presenting the menu on the first layer of the user interface.
